(19) United States
(12) Patent Application Publication
(10) Pub. No.: US 2006/0029770 A1
(43) Pub. Date: Feb. 9, 2006

(54) Flame-retardant heat insulating barrier

(76) Inventor: Jacques Fourmeux, Maing (FR)

Correspondence Address: LADAS & PARRY LLP, 224 SOUTH MICHIGAN AVENUE, SUITE 1600, CHICAGO, IL, 60604, US

(21) Appl. No.: 10/929,198

(22) Filed: Aug. 30, 2004

(30) Foreign Application Priority Data
Aug. 4, 2004 (FR) 04.08628

(51) Int. Cl. B32B 3/10

(52) U.S. Cl. 428/131

(57) ABSTRACT

Flame-retardant thermostable heat insulation barrier, notably for safety clothing, having an outer surface to act as a barrier against an external heat or radiation source, and an inner surface opposite the outer surface, this barrier incorporating a set of holes opening onto the outer and inner surfaces, with a hole density in the order of two per square centimeter, and the holes have a diameter of about one millimeter.

The invention relates to the technical field of heat insulating and flame-retardant textile materials.

The term “heat insulating” in this context refers to textile materials through which, when they are subjected to a heat gradient, the density of heat flow is low.

The term “flame-retardant” refers to thermostable textile materials with good mechanical intactness up to a temperature equivalent to exposure to 400 ° Celsius.

In particular, though not exclusively, the invention relates to heat insulating linings for flame-retardant security clothing.

Many professional activities can involve the risk of direct burns by flames, electric arcs and the projection of hot materials, or indirect burns by heat flash.

Such activities evidently include work carried out by fire-fighters and pyro-metallurgy workers as well as the activities of soldiers, police officers, plane pilots and others employed in the fields of chemistry, metal welding, glass making and the aluminium, energy and transport industries.

Lining for clothing used in these different areas of activity must, in addition to having good heat and temperature resistance properties, have as little as possible an effect on comfort when worn.

Uncomfortable safety clothing may not be worn consistently and the feeling of discomfort can lead to reduced vigilance.

The presence of lining should ideally not be make the clothing overly heavy or bulky.

The presence of lining should not be a disadvantage and, ideally, should not encumber the wearer's freedom of movement or the evaporation of perspiration.

It is also very important to limit the risk of heat stress, a physiological phenomenon resulting from an increase in the internal temperature of the body which is no longer capable of self-regulation.

Heat stress can lead to loss of physical ability, fainting or even a heart attack.

It is reported that in around 50% of cases, the cause of death in fire-fighters in the USA is as a result of heat stress.

Heat insulation linings in flame-retardant safety clothing should also protect the operator and allow him or her time to escape.

There are situations in which there is a very rapid transition phase during the development of fire which leads to an increase in temperature, within a few seconds, from 500 to 600° Celsius, corresponding to an incident heat flux in the order of 40 kW/m².

This is particularly true of “flashover”, the trigger point for a blaze during which fire-fighters can be exposed to radiant heat and convective heat of 40 to 80 kW/m².

Standard EN 367 defines, for an incident heat flux of 80 kW/m² a time t12 corresponding to the threshold of pain and a time t24 corresponding to second degrees burns, where the difference t24−t12 should be greater than 4 seconds and t24 should be greater than 13 seconds to allow the fire-fighter time to withdraw as soon as he feels pain.

The problem of perspiration evacuation is all the more acute where professional activities, such as those of fire-fighters dealing with a fire, have to be carried out in geographic areas where the climate is hot under and conditions of intense stress and physical effort.

This problem is further complicated by the fact that perspiration does not take place in a uniform manner over the body's surface.

This is made more serious when an accumulation of perspiration in the clothing tends to increase heat conductivity and thus decreases the clothing's role as an insulating barrier.

At the same time, the heat resistant properties of a lining material should not suppress the important physical sensation of heat.

In particular, as indicated earlier, the presence of flame-retardant lining should provide an interval separating the threshold of pain from the threshold of irreversible damage that is always higher than the reaction time of the person wearing the clothing.

To take into account these various restrictions, the prior art proposes different technical solutions.

Complex textiles exist incorporating a heat insulating material consisting of a three-dimensional meshed knit as described in document EP-0.443.991 or of a felt capable of imprisoning air as described in document RP-0.364.370.

Application WO-99/35926 describes a membrane in which spacers are arranged at regular intervals in order to create a layer of air between said membrane and the surface of the textile acting as a lining.

Document WO-00/66823 proposes an arrangement of folds made of a textile material at the surface of the lining such that these create air channels between an inflammable textile sheet and the lining.

Documents GB-2,264,705, WO-99/05296, U.S. Pat. No. 5,136,723 and U.S. Pat. No. 5,924,134 can also be referred to.

Conventionally, flame-retardant heat insulation lining is made of fibrous and porous materials.

The use of fibrous and porous materials in these linings is justified by their heat transfer properties.

This transfer takes place through natural radiation, conduction and convection.

Radiation is often the most dominant method of transfer in fibrous materials, all the more so the higher the heat gradient to which they are exposed.

The density of the conduction flux depends on the overall porosity of the fibrous material, the surface volume area of fibres, illustrating its state of division, and on anisotropy and fibre distribution.

The density of natural flux conduction is generally limited in heat insulating fibrous materials.

Insulation provided by a sheet of fibrous material is generally inversely proportional to the density of the material, the density of the constituent fibres and the heat conductibility of its constituents.

This insulation can be proportional to the thickness of the sheet.

The preceding points demonstrate that a flame-retardant insulating lining must comply with a number requirements which are at times contradictory.

Three examples of such contradictions will be given.

A first example relates to the choice of a porosity value for the lining material.

Maximum porosity for the fibrous and porous material of the lining needs to be examined. Air separating the fibres is totally transparent to radiation such that only the fibres are involved in diffusion, absorption and re-emission of infrared radiation.

However, maximum porosity can result in decreased mechanical strength especially to washing and wearing, or in bulkiness which can restrict movement.

A second example is related to the choice of the thickness of the lining material.

Indeed, excessive lining thickness offers high power of insulation as well as reduction in the volume of fibbers per unit of lining volume.

However, excessive lining thickness indeed can restrict the wearer's movements.

Furthermore, a high insulating capacity in a lining should not be obtained at the expense of feelings of pain, keeping in mind that the threshold of pain varies from person to person.

A third example is more fundamentally related to the choice of a lining with a high heat insulation capacity.

Conventionally, the use of a heat barrier against temperature gradients from outside the clothing inwards by that very fact leads to the creation of a heat barrier against temperature gradients from inside the clothing towards the outside.

In hot or desert climates, this can lead to feelings of discomfort with the evacuation of perspiration and body heat impeded by the presence of lining.

Heat and perspiration evacuation are all the more necessary the thicker and heavier the flame-retardant safety clothing.

Conventionally, flame-retardant safety clothing incorporates, from the outer side towards the inner side:
an external fabric, usually aramide based, generally with a surface mass of 200 to 250 g/m²,
an imper-breathable microporous membrane, such as polyurethane or PTFE, assembled on a substrate, generally aramide fibres or assembled onto another layer,
an insulating heat barrier, generally consisting of non-woven aramide fibres,
hygiene lining, generally 100% aramide or 50% aramide, 50% viscose FR, to protect the heat barrier.

Conventionally, flame-retardant heat insulating barriers are based on, by the nature of the fibres employed, non-woven fabrics, heat stable and non-inflammable fabrics or knits.

The applicant previously proposed flame-retardant thermostable barriers comprised of non-woven needled felts made of aramide fibres, these felts being equipped with wide diameter perforations with a high hole density: hole diameter 2 to 3 mm, hole density in the order of 2/cm².

The perforation of non-woven aramide fibres causes significant industrial problems as a result of the very high mechanical resistance of these fibres.

Making holes in the heat barriers leads to loss of mechanical resistance in the lining, causing a problem with the washing of flame-retardant clothing (see ISO standard 6330).

Heat barriers of the prior art only comply partially with user requirements, especially in terms of heat exchange capacity from the inner to the outer side.

An object of the invention is to provide a flame-retardant thermostable heat insulating barrier which allows enhanced evacuation of heat and body perspiration such that the person using clothing with such a heat barrier feels it like a second skin, this at the same time as conserving good anti-fire protection and heat flash protection properties, with the heat barrier improving the quality of the protective clothing, in particular fire-fighter clothing, in terms of convective heat (standard EN 367) and for protection against radiant heat (ISO 6942) without a negative effect on resistance to washing (ISO standard 6330).

To this end, according to a first aspect of the invention relates to a flame-retardant thermostable heat insulation barrier, notably for safety clothing, consisting of an outer surface to act as a barrier against an external heat or radiation source, and an inner surface opposite the outer surface, this barrier incorporating a set of holes opening onto the outer and inner surfaces, with a hole density in the order of two per square centimetre, characterised in that the holes have a diameter in the order of millimetres.

According to various embodiments, the barrier has the following features, possibly in combination:
holes are almost identical and arranged in the shape of a rectangular or square meshwork,
their thickness in the order of 1 to 5 millimetres,
they are made of a material chosen from the group consisting of imide polyamides, polyimides (P.I.), aramides, para aramides, meta aramides, polyacrylates, aromatic copolyimides, polyacrylonitriles, polyester-ether-ketone, polybenzimidazole, polytetrafluorethylene (P.T.F.E.), polysulfones (P.S.O.), polyethersulfones (P.E.S.), polyphenylsulfones and phenylene polysulfides (P.P.S.), mixture of aramide and polybenzimidazole, mixture of heat-stabilized polyacrylonitrile and polyamide, polytrifluorochloroethylenes (P.T.F.C.E.), tetrafluorethene-perfluoroprene copolymers (F.E.P.),
they are made of a material which also contains the fibres chosen from the group consisting of metal fibres, glass fibres, “non-fire” viscose fibres, carbon fibres, peroxidated carbon fibres, silica fibres, modacrylic fibres,
they are in the form of a non-woven material, in particular by waterjet binding,
they are made up of aramide fibres, in particular pure, substandard or recycled fibres.

According to a second aspect of the invention relates to a manufacturing method for an insulating barrier which includes a needling step.

A third aspect of the invention relates to clothing consisting of:
an aramide-based external fabric,
an imper-breathable microporous membrane,
said insulating heat barrier,
internal hygiene lining.

In one embodiment, the microporous membrane is made of a sheet of phosphorated polyurethane assembled onto an aramide fibre substrate.

Other aspects and advantages of the invention will become apparent from the following description of the embodiment.

Following a manufacturing anomaly in the course of research, the applicant found that making perforations in an aramide fibre needled non-woven material, with hole diameters in the order of one millimetre and a hole density in the order of three per square centimetre gave rise to evaporative resistance (NF EN 31092), heat resistance and permeability index (ISO 11092) values which exceeded all expectations and this without a negative effect on the mechanical properties of such a non-woven fabric (ISO 9073).

The description below presents the results obtained. Firstly, however, a brief description of the standard tests is given.

I—Evaporative Resistance According to NF EN 31092

Evaporative resistance measures the barrier to passage of water vapour and thus to evaporation of sweat from the skin, which constitutes one aspect of clothing.

The higher this value, the greater the barrier to perspiration: a product with good “breathability” has low evaporative resistance.

ISO standard 110 92 defines measurement conditions which are similar to the conditions of skin saturated with humidity. The apparatus used for this measurement is called a “skin model”.

A 20 cm porous metal plate simulates skin. It is heated to 35° C. by internal electric resistances and its surface is kept saturated by an auxiliary device which compensates for evaporation produced at the plate's surface.

The test tube is placed on the measurement plate with its upper side swept by a parallel air flux of 1 m/s. Ambient conditions during the test are 35° C. and 40% relative humidity.

Under the effect of a difference in humidity between the saturated plate (35° C., 100% RH) and drier ambient air (35° C., 40% RH), water vapour is transferred through the test tube. The resulting evaporation at the plate surface cools the latter and the electrical energy supplied to the plate to maintain its temperature is measured.

Evaporative resistance is defined by:
Rₑ=(Pₛₖᵢₙ−Pₐᵢᵣ)/Hₑ
Pₛₖᵢₙ−Pₐᵢᵣ: difference in humidity (water vapour partial pressure in Pa) between the saturated measurement plate and ambient air;
Hₑ: electrical resistance supplied in order to maintain the plate at its initial temperature of 35° C. when water evaporates at its surface to transfer across the test tube (in W/m²).

The unit for evaporative resistance is m².Pa/W (square metre Pascal per Watt).

Resistance Rₑₜ defined by ISO 11092 is the difference between resistance Rₑ measured when the test tube covers the measurement plate and the vacuum value Rₑ₀ of the apparatus, measured without the test tube.

For the purpose of comparison, the evaporative resistance of 1 mm of still air (no internal convention) is 2.2 m².Pa/W.

The table below gives the results for:
a felt R1 made of ISOMEX® fibres 95 g/m² thickness 1.7 mm, perforated according to the invention;

a felt made of the same fibres 100 g/m² thickness 1.7 mm, non-perforated.

| | Evaporative resistance | | | Mean evaporative resistance | |
|---|---|---|---|---|---|
| References | Rₑₜ of test tubes m² · Pa/W | | | Rₑₜ m² · Pa/W | |
| R1 | 7.0 | 6.7 | 6.6 | 6.7 | ±0.4 |
| R2 | 10.0 | 10.3 | 10.0 | 10.1 | ±0.4 |

Repeatability of the measurement:
Rₑₜ<10 m².Pa/W±0.15 m².Pa/W
Rₑₜ>10 m².Pa/W±3.5%

II—Heat Resistance According to ISO 11092

Heat resistance measures the product's insulation.

The higher the heat resistance, the greater the insulation and the hotter the product is.

ISO standard 11092 defines measurement conditions which are similar to the conditions of skin saturated with humidity. The apparatus used for this measurement is called a “skin model”.

A 20 cm×20 cm porous metal plate which simulates skin is heated to 35° C. by an internal electric resistance.

The test tube is placed on the measurement plate with its upper side swept by a parallel air flux of 1 m/s. The temperature is 20° C. and relative humidity is at 65%.

Under the effect of a difference in humidity between the saturated plate and ambient air, heat transfer takes place through the test tube. The electrical energy supplied to the plate to maintain temperature at 35° C. is measured.

Heat resistance is defined by:
Rₑ=(Tₛₖᵢₙ−Tₐᵢᵣ)/Hₑ
Tₛₖᵢₙ−Tₐᵢᵣ: difference in temperature between the measurement plate and ambient air (in ° C. ou K);
Hₑ: electrical resistance supplied to the plate in order to maintain its temperature at 35° C. (in W/m²).

The heat resistance unit is m².K/W (square metre degree Kelvin per Watt).

Resistance Rₑₜ defined by ISO 11092 is the difference between resistance Re measured when the test tube covers the measurement plate and the vacuum value Rₑ₀ of the apparatus, measured without the test tube.

For the purpose of comparison, the heat resistance of 1 mm of still air (no internal convention movement) is 0.037 m².K/W.

The table below gives the results for previously defined non-woven materials R1 and R2.

| | Heat resistance | | | Mean heat resistance | |
|---|---|---|---|---|---|
| References | Rₑₜ of test tubes m² · K/W | | | Rₑₜ m² · K/W | |
| R1 | 0.077 | 0.084 | 0.078 | 0.080 | ±0.008 |
| R2 | 0.129 | 0.123 | 0.126 | 0.126 | ±0.006 |

Repeatability of the measurement:
R_{ct}<0.050 m².K/W±0.015 m².K/W
R_{ct}>0.050 m².K/W±3.5%

III—Permeability Index According to ISO 11092

The permeability index iₘₜ is defined with reference to the ratio of resistance Rₑ to evaporative resistance Rₑₜ of the product, measured according to ISO 11092, referred to the value for the same product in still air:
iₘₜ=(R_{ct}/Rₑₜ)product/(R_{ct}/Rₑₜ) air=60. R_{ct}/Rₑₜ
R_{ct}: heat resistance of the product (in m².K/W)
Rₑₜ: evaporative resistance (in m².Pa/W)
60: Ratio 1/(R_{ct}/Rₑₜ) for still air (in Pa/K).

A hot product is expected to be insulating but must also allow perspiration to be evacuated. It should therefore have high heat resistance and low evaporative resistance. In other words, the highest possible permeability index iₘₜ. As air is the hottest and most breathing product known, the permeability index value must be between 0 (non-breathing material with very high evaporative resistance) and 1 (ideal case corresponding to still air).

The comfort zone of piece of clothing:

For a given activity, the comfort zone of clothing is defined by two extreme temperatures, tₘᵢₙ and tₘₐₓ:
tₘᵢₙ: temperature at which cold is felt
tₘₐₓ: temperature at which wet skin begins to feel uncomfortable as a result of sweat production which exceeds the fabric's evacuation capacity.

The comfort zone of a piece of clothing is the difference between (tₘᵢₙ and tₘₐₓ). A high value means the clothing self-adapts to very different conditions of use (room temperature, activity, poorly ventilated body parts) which requires either heat insulation or sweat evacuation, depending on the case in question. It is therefore not necessary to put on or take off layers of clothing when the conditions of use change.

The temperature tₘᵢₙ is determined by the heat resistance value R_{ct} (high R_{ct}=low tₘᵢₙ=hot clothing).

The comfort zone (tₘᵢₙ−tₘₐₓ) is linked to the permeability index iₘₜ (high iₘₜ=extended comfort zone=good adaptability=high level of comfort).

The table below gives the results for previously defined non-woven materials R1 and R2.

| | R_{ct} | Rₑₜ | |
|---|---|---|---|
| References | m² · K/W | m² · K/W | iᵢₘ |
| R1 | 0.080 | 6.7 | 0.71 ± 0.11 |
| R2 | 0.126 | 10.1 | 0.75 ± 0.06 |

IV—Mechanical Resistance

The tests are conducted according to ISO standard 9073-1 (surface density), ISO 9073-2 (thickness under a load of 0.5 kPa) and ISO 9073-3 (tenacity and elongation at break).

The results are given in the table below:

| | R1 | R2 | R3 |
|---|---|---|---|
| Surface density (g/m2) | 95 | 90 | 120 |
| Thickness under a load of 0.5 kPa (mm) | 2 | 2 | 2.10 |
| Tenacity (N) | | | |
| transverse direction | 70 | 4 | 18 |
| longitudinal direction | 70 | 6 | 25 |
| Elongation at break (%) | | | |
| transverse direction | 90 | 60 | 100 |
| longitudinal direction | 70 | 50 | 70 |

The non-woven material R1 is the one defined previously. It consists of millimetre sized holes placed along a rectangular mesh design with a hole density in the order of three per square centimetre.

The non-woven material R1 consisting of ISOMEX® needled perforated aramide fibres complies with EN 532.

The non-woven material R3 also consists of ISOMEX® needled perforated aramide fibres. It consists of millimetre sized holes placed along a square mesh design with the mesh parameter in the order of 4 mm.

The non-woven material R4 is also a needled perforated material consisting of ISOMEX® aramide fibres. It consists of two types of holes similar to those described previously in the reference to figure of the applicant's document EP-1.129.633.

This non-woven material R4 illustrating the prior art has an evaporative resistance of 7 m².Pa/W with a value of 6.8 for a non-perforated felt.

The non-woven material R1 with a hole density of about two times less than R4 is ten times more resistant to tearing although it is lighter (95 versus 120 g/m²). Moreover, the non-woven material R1 has lower evaporative resistance than the previous non-woven R4 (6.7 versus 7 m².Pa/W).

The non-woven material R1 thus provides a good compromise, well beyond the expectations of the man skilled in the art, between good breathability (evaporative resistance value), sufficient mechanical resistance for the product to be handled without the risk of tearing, is very light (cover of 25 g/m², i.e. 20% compared to the previous non-woven R4) and has heat performances similar to those of a non-perforated felt.

The applicant has conducted tests according to NF EN 367, NF EN 366, NF EN 469 on a four-layer complex:
external fabric,
imper-breathable microporous PU membrane,
non-woven R1,
hygiene lining.

The following values were obtained for NF EN 367:
HTI₁₂=11
HTI₂₄=15
for a capacity of 80.75 kW/m² (3 tests).

The outer carbonised layer, as well as the PU membrane, blacken and the lining remains intact.

Three tests were performed for the test according to NF EN 366, protocol NF EN 469 (method B):

| | Incident | Transmitted | Transmission |
|---|---|---|---|
| | flux | flux | factor |
| Test tubes | q₀ in kW/m² | q₀ in kW/m² | TF (q₀) |
| 1 | 40.04 | 14.6 | 36.5 |
| 2 | 40.04 | 15.0 | 37.4 |
| 3 | 40.04 | 14.3 | 35.8 |
| Mean | 40 | 15 | 37 |

| Test tubes | T1 in s | t2 in s | t3 in s |
|---|---|---|---|
| 1 | 19.3 | 26.6 | 8.0 |
| 2 | 18.6 | 25.8 | 9.0 |
| 3 | 19.7 | 27.0 | 11.0 |
| Mean | 19 | 26 | 9 |

such that t2-t1 is equal to 7 with:
t1: intersection time of the temperature curve with the level 1 curve (threshold of pain),
t2: intersection time of the temperature curve with the level 1 curve (threshold of second degree burns),
t3: time needed for the heat flux transmitted to reach 2.5 kW/m²

The external layer carbonises, the membrane melts, the felt blackens and the lining remains intact.

The embodiments which were described above are not limiting.

Other thermostable synthetic fibres can be used such as:
melamine fibres, for example Basofil®,
aromatic polyamide fibres, for example P84® produced by Lenzing,
phenolic fibres, for example Kynol® produced by Nippon Kynol or Philene® produced by Saint Gobain,
panpreox fibres, for example Panox® produced by RK Carton Ltd or Sigrafil® produced by Sigri,
polyacrylate fibres for example Inidex® produced by Courtaulds,
polybenzimidazole fibres for example PBI® produced by Hoechst Celanese.

These non-woven needled materials can be developed from mixtures of aramide fibre such as Normex®, Isomex® or Kevlar® produced by Dupont de Nemours, or Kermel® fibres, Teijin Conex® fibres or Technora® fibres produced by Teijin Ltd, Twaron® produced by Akzo, Apyeil® by Unitika or HMA® produced by Hoechst.

In some embodiments, the density of perforation is not uniform.

Thus, when the heat barrier is used as an insulator in flame-retardant clothing, a higher hole density can be anticipated for body areas which are in principle exposed to the risk of direct or indirect burns.

Similarly, if the heat barrier is used as an insulator for a fire protection hood, more perforations can be inserted towards the right of the wearer's ears.

The invention also relates to flame-retardant safety clothing comprised of, from the outside inwards:
external fabric,
microporous membrane,
said flame-retardant thermostable heat barrier,
internal hygiene lining.

The evaporative resistance value for clothing of the type mentioned above, equipped with conventional lining, generally ranges from 22 to 30 bar. m²/W.

Such values are reached when an Isomex® non-woven fiber of 100 g/m² is used.

The use of fibers of the Isomex® type makes it possible to get a lower value of evaporative resistance of at least 22 bar.m²/W.

Making perforations to an Isomex® needled non-woven material can improve the evaporative resistance value by 10 to 30%.

In certain embodiments, the external fabric is substantially impermeable.

This property is particularly important for certain fire fighting activities or where the surrounding atmosphere is potentially harmful or toxic.

In certain embodiments, the external fabric is equipped with phosphorescent and/or fluorescent strips.

The microporous membrane is, for example, made of Gore-tex® or a phosphorated polyurethane assembled on an aramide fibre substrate.

Depending on the anticipated exposure temperature, various types of fibres can be used to make up a non-woven heat barrier.

For high exposure temperatures, fibres of the following type can be used:
imide polyamides, polyimides (P.I.),
aramides such as Kernel®, Teijin Conex®, Kevlar®, Twaron®, Tecnora®,
para aramides, meta aramides,
polyacrylates such as Inidex®,
aromatic copolyimides,
polyacrylonitrile,
polyester-ether-ketone,
polybenzimidazole for example PBI® fibres produced by Celanise Corp.,
polytetrafluorethylene (P.T.F.E.),
modacrylics,
polyphenylsulfone,
phenylene polysulfide (P.P.S.).

Mixtures of the above-mentioned fibres can also be used, such as in particular:
mixture of aramide and polybenzimidazole,
mixture of heat-stabilized polyacrylonitrile and polyamide,

Otherwise, the above-mentioned fibres, particularly the polyaramides, can be mixed with glass, carbon or silica fibres.

For lower exposure temperatures, the following fibre types can be used:
polytrifluorochloroethylenes (P.T.F.C.E.),
tetrafluorethene-perfluoroprene copolymers (F.E.P.),
polysulfones (P.S.O.),
polyethersulfones (P.E.S.),
P.B.O.

Where mechanical resistance and resistance to washing are desired, especially for perforated needled non-woven felts, these can be sewn using non-rectilinear lines, for example wavy lines, along the flame-retardant membrane.

1. A flame-retardant thermostable heat insulation barrier, in particular for safety clothing, comprising an outer surface to act as a barrier against an external heat or radiation source, and an inner surface opposite the outer surface, the barrier incorporating a set of holes opening onto the outer and inner surfaces, with a hole density in the order of two per square centimeter, wherein the holes have a diameter of about one millimetre.

2. A barrier according to claim 1 wherein the holes are substantially identical and arranged in a rectangular or square mesh.

3. An insulating barrier according to claim 1 wherein the barrier has a thickness is within the range of 1-5 millimetres.

4. An insulating barrier according to claim 1, wherein the barrier is made of a material chosen from the group consisting of imide polyamides, polyimides (P.I.), aramides, para aramides, meta aremides, polyacrylates, aromatic copolyimides, polyacrylonitriles, polyester-ether-ketone, polybenzimidazole, polytetrafluorethylene (P.T.F.E.), polysulfones (P.S.O.), polyethersulfones (P.E.S.), polyphenylsulfones and phenylene polysulfides (P.P.S.), mixture of aramide and polybenzimidazole, mixture of heat-stabilized polyacrylonitrile an dpolyamide, polytrifluorochloroethylenes (P.T.F.C.E.), tetrafluorethene-perfluoroprene copolymers (F.E.P.), and Poly-p-phenylene benzobisoxazole.

5. An insulating barrier according to claim 4 wherein the barrier is also made of a material containing the fibres chosen from the group consisting of metal fibres, glass fibres, “non-fire” viscose fibrers, carbon fibres, peroxidated carbon fibres, silica fibres, and modacrylic fibres.

6. An insulating barrier according to claim 1, wherein the barrier is made from a non-woven material.

7. An insulating barrier according to claim 6 wherein the barrier is made by waterjet binding.

8. An insulating barrier according to claim 6 wherein the barrier is made of aramide fibres.

9. A method for the manufacture of an insulating barrier such as that presented in claim 6 wherein the method includes a needling step.

10. A flame-retardant protective clothing at least one insulating heat barrier according to claim 1.

11. Clothing according to claim 10 comprising:
an external aramide-based fabric,
an imper-breathable microporous membrane
said insulating heat barrier, and
an internal hygiene lining.

12. Clothing according to claim 11 wherein the microporous membrane is made of a sheet of phosphorated polyurethane assembled onto an aramide fibre substrate.
